(19) United States
(12) Patent Application Publication
(10) Pub. No.: US 2013/0290508 A1
(43) Pub. Date: Oct. 31, 2013

(54) METHODS AND APPARATUS TO MEASURE EXPOSURE TO STREAMING MEDIA

(71) Applicants: Jan Besehanic, Tampa, FL (US); Alan Bosworth, Odessa, FL (US); Arun Ramaswamy, Tampa, FL (US)

(72) Inventors: Jan Besehanic, Tampa, FL (US); Alan Bosworth, Odessa, FL (US); Arun Ramaswamy, Tampa, FL (US)

(21) Appl. No.: 13/455,961

(22) Filed: Apr. 25, 2012

(51) Int. Cl. G06F 15/16

(52) U.S. Cl. 709/224

(57) ABSTRACT

Methods and apparatus to measure exposure to streaming media are described. An example method includes extracting metering data from media obtained from a media provider. Metadata identifying the media based on the extracted metering data is generated. The media is transcoded into a transport stream, the transport stream having a streaming format. The metadata is embedded in a timed text track accompanying the transport stream.

### FIELD OF THE DISCLOSURE

This disclosure relates generally to measuring media exposure, and, more particularly, to methods and apparatus to measure exposure to streaming media.

### BACKGROUND

Streaming enables media to be delivered to and presented by a wide variety of media presentation devices, such as desktop computers, laptop computers, tablet computers, personal digital assistants, smartphones, etc. A significant portion of media (e.g., content and/or advertisements) is presented via streaming to such devices.

### BRIEF DESCRIPTION OF THE DRAWINGS

FIG. 1 is a diagram of an example system for measuring exposure to streaming media.

FIG. 2 is a block diagram of an example implementation of the media monitor of FIG. 1.

FIG. 3 is example Hypertext Markup Language (HTML) code representing a web page that may be displayed by the example client device of FIG. 2.

FIG. 4 illustrates example timed text track code representing an example timed text track that may be used by the example media monitor of FIG. 2.

FIG. 5 is a flowchart representative of example machine-readable instructions which may be executed to implement the example service provider of FIG. 1

FIG. 6 is a flowchart representative of example machine-readable instructions which may be executed to implement the example media monitor of FIGS. 1 and/or 2.

FIG. 7 is a block diagram of an example implementation of an example HLS stream that may be delivered to the example media monitor of FIG. 2.

FIG. 8 is a block diagram of an example processor platform capable of executing the example machine-readable instructions of FIGS. 5 and/or 6 to implement the example service provider of FIG. 1 and/or the example media monitor of FIGS. 1 and/or 2.

### DETAILED DESCRIPTION

Example methods, apparatus, systems, and articles of manufacture disclosed herein may be used to measure exposure to streaming media. Some such example methods, apparatus, and/or articles of manufacture measure such exposure based on media metadata, user demographics, and/or media device types. Some examples disclosed herein may be used to monitor streaming media transmissions received at client devices such as personal computers, tablets (e.g., an iPad®), portable devices, mobile phones, Internet appliances, and/or any other device capable of playing media. Some example implementations disclosed herein may additionally or alternatively be used to monitor playback of media which is locally stored in media devices. Example monitoring processes disclosed herein collect media metadata associated with media presented via media devices and associate the metadata with demographics information of users of the media devices. In this manner, detailed exposure metrics are generated based on collected media metadata and associated user demographics.

The use of mobile devices (e.g., smartphones, tablets, MP3 players, etc.) to view media has increased in recent years. Initially, service providers created custom applications (e.g., apps) to display their media. As more types of mobile devices having different software requirements, versions, compatibilities, etc., entered the market, service providers began displaying streaming media in a browser of the mobile device. Consequently, many users view streaming media via the browser of their mobile device. In view of the increasing popularity of accessing media in this manner, understanding how users interact with the streaming media (e.g., such as by understanding what media is presented, how the media is presented, etc.) provides valuable information to service providers, advertisers, content providers, manufacturers, and/or other entities.

In the examples illustrated herein, media is received from a media provider such as, for example, a satellite provider, a cable provider, a physical media provider (e.g., a Digital Versatile Disk (DVD)-by-mail service, etc.). The media is provided to be streamed from a service provider to one or more client devices for presentation thereon. In the illustrated example, the media is provided as a transport stream. In some examples, metering data having a first format is extracted from the transport stream. In some such examples, the transport stream corresponds to a Moving Picture Experts Group (MPEG) 2 transport stream sent according to a hypertext transfer protocol (HTTP) live streaming (HLS) protocol. However, the transport stream may additionally or alternatively correspond to and/or be sent according to any other past, present, or future format such as, for example, MPEG 4, an HTTP Secure protocol (HTTPS), a file transfer protocol (FTP), a secure file transfer protocol (SFTP).

Audio watermarking is a technique used to identify media such as television broadcasts, radio broadcasts, downloaded media content, streaming media content, prepackaged media content, etc. Existing audio watermarking techniques identify media by embedding audio codes (e.g., a watermark), such as identifying information, into an audio and/or video component having a signal level sufficient to hide the watermark. As used herein, the terms “code” or “watermark” are used interchangeably and are defined to mean an identifier that may be inserted or embedded in the audio or video of media (e.g., a program or advertisement) for the purpose of identifying the media or for another purpose such as tuning (e.g., a packet identifying header).

Unlike media monitoring techniques based on codes and/or watermarks included with and/or embedded in the monitored media, fingerprint or signature-based media monitoring techniques generally use one or more inherent characteristics of the monitored media during a monitoring time interval to generate a substantially unique proxy for the media. Such a proxy is referred to as a signature, and can take the form of a series of digital values, a waveform, etc., representative of the media signal(s), such as the audio and/or video signals, forming the media presentation being monitored. A good signature is usually one that is repeatable when processing the same media presentation, but that is unique when processing other presentations of other media. Accordingly, the term “fingerprint” and “signature” are used interchangeably and are defined to mean a proxy for identifying media that is generated from one or more inherent characteristics of the media.

Signature-based media monitoring generally involves determining (e.g., generating and/or collecting) signature(s) representative of a media signal (e.g., an audio signal and/or a video signal) output by a monitored media device and comparing the monitored signature(s) to one or more references signatures corresponding to known (e.g., reference) media sources. Various comparison criteria, such as a cross-correlation value, a Hamming distance, etc., can be evaluated to determine whether a monitored signature matches a particular reference signature. When a match between the monitored signature and one of the reference signatures is found, the monitored media can be identified as corresponding to the particular reference media source represented by the reference signature that matched the monitored signature. Because attributes, such as an identifier of the media, a presentation time, a broadcast channel, etc., are collected for the reference signature, these attributes may then be associated with the monitored media whose monitored signature matched the reference signature.

In some examples, metadata embedded in the media is in a first format (e.g., a watermark, a signature, a code, etc.). In some examples, the metering data having the first format includes an audio watermark that is embedded in an audio portion of the media. Additionally or alternatively, the metering data having the first format can include a video (e.g., image) watermark that is embedded in a video portion of the media. Many client devices do not have access to the metadata in the first format, and/or in some cases, enough processing power to identify the metadata in the first format. Thus, in the examples illustrated herein, the service provider identifies the watermark, and converts the metadata into a second format readable by the client device. The metadata in the second format may correspond to, for example, metadata represented in a text format, such as a text format for inclusion in a timed text track file sent in association with the streaming media.

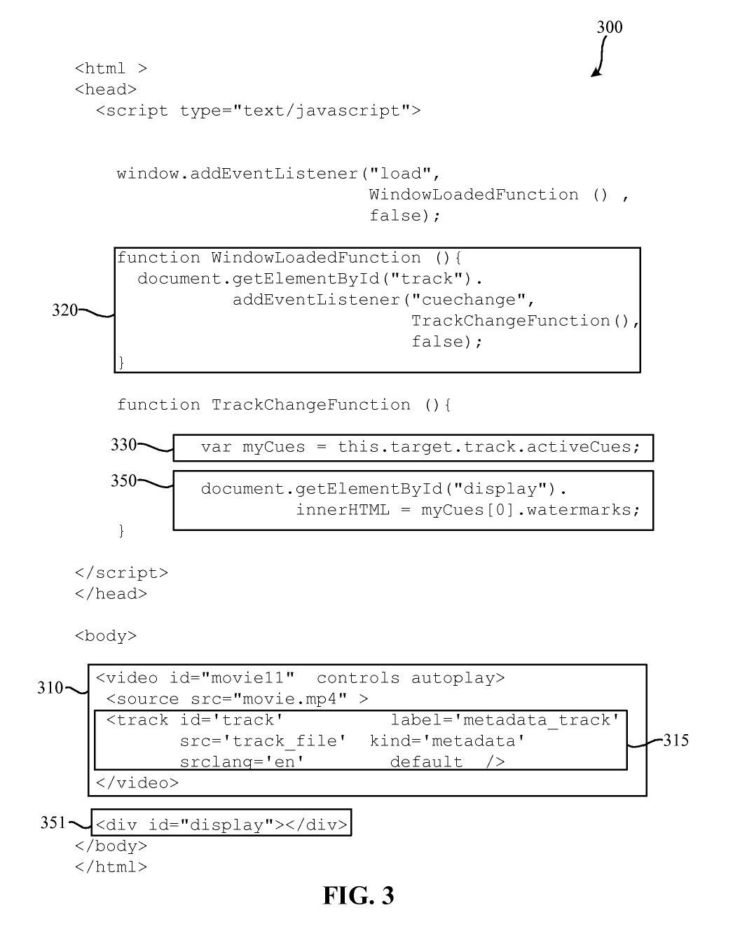

A timed text track is a document and/or file that is linked to, transmitted with, and/or embedded in a web page that causes display of media. The timed text track defines times for displaying text (e.g., closed captioning, subtitles, comments, advertisements, metadata, etc.) at corresponding places and/or times associated with the presentation of the media. For example, the timed text track may specify that the phrase “This is a patentable invention” should be displayed at time 00:01:12 after the start of the media presentation should the closed captioning option be utilized by the displaying device (e.g., a television, etc.). In the examples illustrated herein, the timed text track is identified in a web page for displaying media. An example web page showing an example manner in which a timed text track may be associated with media is shown in FIG. 3. In the illustrated example, the timed text track is requested separately from the web page based on a source attribute of a timed text track tag in the web page. Thus, the timed text track is linked to the web page, but not bodily incorporated therein in the example of FIG. 3. However, in some examples, the timed text track is included in the web page.

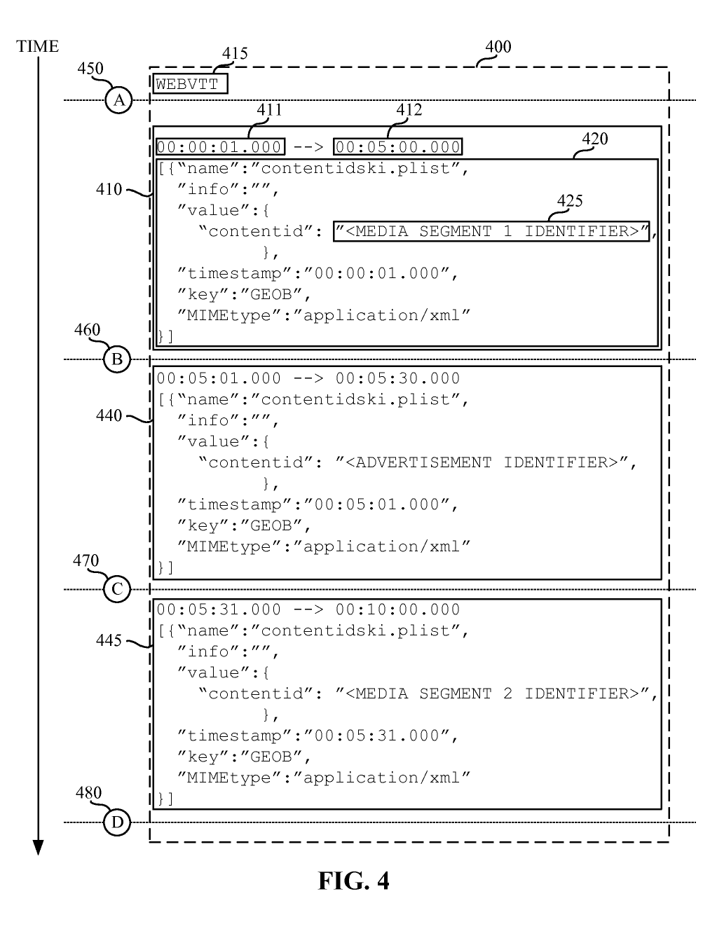

The timed text track document includes start cues, end cues, and data associated with those cues. The start cues and end cues define times in the associated media that trigger an event associated with the timed text track. In some examples, the timed text track document is used to cause the display of subtitles and/or captioning data defined in the data associated with the cues. Upon reaching a start cue, the subtitles and/or captioning data are displayed. Upon reaching an end cue, the subtitles and/or captioning data are removed from display. An example timed text track file is shown in FIG. 4.

In some disclosed examples, streaming media is delivered to the client device using HTTP Live Streaming (HLS) via a HyperText Markup Language version 5 (HTML5) web page. However, any other past, present, and/or future method of streaming media to the client device may additionally or alternatively be used such as, for example, an HTTP Secure (HTTPS) protocol. Additionally or alternatively, any other past, present, and/or future web page language may additionally or alternatively be used. The HyperText Markup Language version 5 (HTML5) allows metadata to be included in a timed text track and/or otherwise associated with, for example, a media stream, etc. In some disclosed examples, a client device uses a browser to display media received via HLS. Additionally or alternatively, in some disclosed examples the client device uses a media presenter (e.g., a browser plugin, an app, a framework, an application programming interface (API), etc.) to display media received via HLS.

In some examples illustrated herein, the client device requests the web page from a service provider. In some examples illustrated herein, the webpage defines a timed text track document that is to be separately requested by the client device. In some examples, the timed text track document is hosted by the service provider. However, in other examples, the timed text track document is hosted by an entity other than the service provider such as, for example, the central facility of the audience measurement entity, etc. In some examples, the timed text track is included in the web page such that no additional request is needed to access the timed text track document.

In examples illustrated below, media exposure metrics are monitored by retrieving metadata transported in the timed text track. In some examples, the metadata is retrieved via a Document Object Model (DOM) object. The DOM is a cross-platform and language-independent utility for representing and interacting with objects in Hypertext Markup Language (HTML). However, any other past, present, and/or future format, language, protocol, etc. may additionally or alternatively be used such as, for example, HTML5. The DOM provides an internal representation of the web page being presented. Accessing the DOM via, for example, JavaScript, enables access to objects defined in the web page including, for example, the timed text track.

In some examples, the metadata is stored in an ID3 tag format within the timed text track, although any other past, present, and/or future metadata format may additionally or alternatively used. In some examples, media presenters (e.g., media plugins) such as, for example, the QuickTime player, emit DOM events such as, for example cue change events triggered by a defined cue in the timed text track. In the examples illustrated herein, the DOM events are captured via JavaScript. However, any other past, present, and/or future script, language, instruction set etc. may additionally or alternatively be used. By capturing the DOM events, it is possible to extract the metadata (e.g., the ID3 tag data) of the timed text track events via the DOM. Once extracted, the metadata may be combined with other information such as, for example, cookie data associated with the device, a timestamp, etc. and transmitted to, for example, a central facility for analysis and/or compilation with data collected from other devices.

Example methods, apparatus, systems, and articles of manufacture disclosed herein involve extracting or collecting metadata (e.g., metadata stored in an ID3 tag, extensible markup language (XML) based metadata, and/or metadata in any other past, present, and/or future format) associated with streaming media transmissions (e.g., streaming audio and/or video) at a client device. In some examples, the metadata identifies one or more of a genre, an artist, a song title, an album name, a transmitting station/server site, etc. In such examples, highly granular (e.g., very detailed) data can be collected. Whereas in the past ratings were largely tied to specific programs or broadcasting stations, example methods, apparatus, systems, and/or articles of manufacture disclosed herein can generate ratings for a genre, an artist, a song, an album/CD, a particular transmitting/server site, etc. in addition to, or as an alternative to, generating ratings for specific programs (e.g., radio, television, etc.), advertisements, content providers, broadcasters, and/or stations.

In some examples, metadata collection may be triggered based on media change events detected in media players (e.g., a media presentation event such as, for example, a change defined in a timed text track, a start event, a stop event, a skip event, etc.). A media change event typically causes a change in information identified by the extracted metadata (e.g., a change in genre, a change in artist, a change in title, etc.) and, thus, can be a useful trigger for data collection. In some examples, media change events are detected while the media is being played. In the illustrated example, media change events are detected when there is a change associated with a timed text track of the streaming media (e.g., upon detection of a timed text track event, etc.). In some examples, the collected metadata is time stamped based on its time of collection.

Example methods, apparatus, systems, and articles of manufacture disclosed herein collect demographic information associated with users of client devices based on identifiers (e.g., an Internet protocol (IP) address, a cookie, a device identifier, etc.) associated with those client devices. Media exposure information may then be generated based on the media metadata and the user demographics corresponding to the identifier to indicate exposure metrics and/or demographic reach metrics for at least one of a genre, an artist, an album name, a transmitting station/server site, etc.

In some examples, it is desirable to link demographics to the monitoring information. To address this issue, the audience measurement entity establishes a panel of users who have agreed to provide their demographic information and to have their streaming media activities monitored. When an individual joins the panel, they provide detailed information concerning their identity and demographics (e.g., gender, race, income, home location, occupation, etc.) to the audience measurement entity. The audience measurement entity sets an identifier (e.g., a panelist cookie) on the presentation device that enables the audience measurement entity to identify the panelist whenever the panelist reports access to streamed media. In particular, each panelist is provided with a media monitor that reports access(es) to streamed media to a central facility of the audience measurement entity. In some examples, the media monitor reports access(es) to streamed media as the access(es) occur (e.g., streaming). In some examples, the media monitor caches (e.g., stores, buffers, etc.) the access(es) to streamed media and transmits the cached access(es) to the central facility. In the illustrated example, the media monitor transmits the identifier along with the access(es) (e.g., in the form of a cookie).

Example methods, apparatus, systems, and articles of manufacture disclosed herein may also be used to generate reports indicative of media exposure metrics on one or more different types of client devices (e.g., personal computers, portable devices, mobile phones, tablets, etc.). For example, an audience measurement entity may generate media exposure metrics based on metadata extracted from the streaming media at the client device and/or similar devices. A report is then generated based on the media exposure to indicate exposure measurements (e.g., for a type of media (e.g., a genre)) using different types of client devices. Thus, for example, reports indicating the popularity of watching, for instance, sports events on certain types of client devices (e.g., mobile devices, tablets, etc.) can be compared to other popularities of watching sports events on other types of client devices (e.g., televisions, personal computers, etc.).

Additionally or alternatively, popularities of different types of media across different device types may be compared. Such different types of media may be, for example, news, movies, television programming, on-demand media, Internet-based media, games, streaming games, etc. Such comparisons may be made across any type(s) and/or numbers of devices including, for example, cell phones, smart phones, dedicated portable multimedia playback devices, iPod® devices, tablet computing devices (e.g., an iPad®, etc.), standard-definition (SD) televisions, high-definition (HD) televisions, three-dimensional (3D) televisions, stationary computers, portable computers, Internet radios, etc. Any other type(s) and/or number of media and/or devices may be analyzed. The report may also associate the media exposure metrics with demographic segments (e.g., age groups, genders, ethnicities, etc.) corresponding to the user(s) of the client device(s). Additionally or alternatively, the report may associate the media exposure metrics with metric indicators of popularity of artist, genre, song, title, etc., across one or more user characteristics selected from one or more demographic segment(s), one or more age group(s), one or more gender(s), and/or any other user characteristic(s).

In some examples, the media exposure metrics are used to determine demographic reach of streaming media, ratings for streaming media, engagement indices for streaming media, user affinities associated with streaming media, broadcast media, and/or any other audience measure metric associated with streaming media and/or locally stored media. In some examples, the media exposure metrics are audience share metrics indicative of percentages of audiences for different device types that accessed the same media. For example, a first percentage of an audience may be exposed to news media via smart phones, while a second percentage of the audience may be exposed to the same news media via tablets.

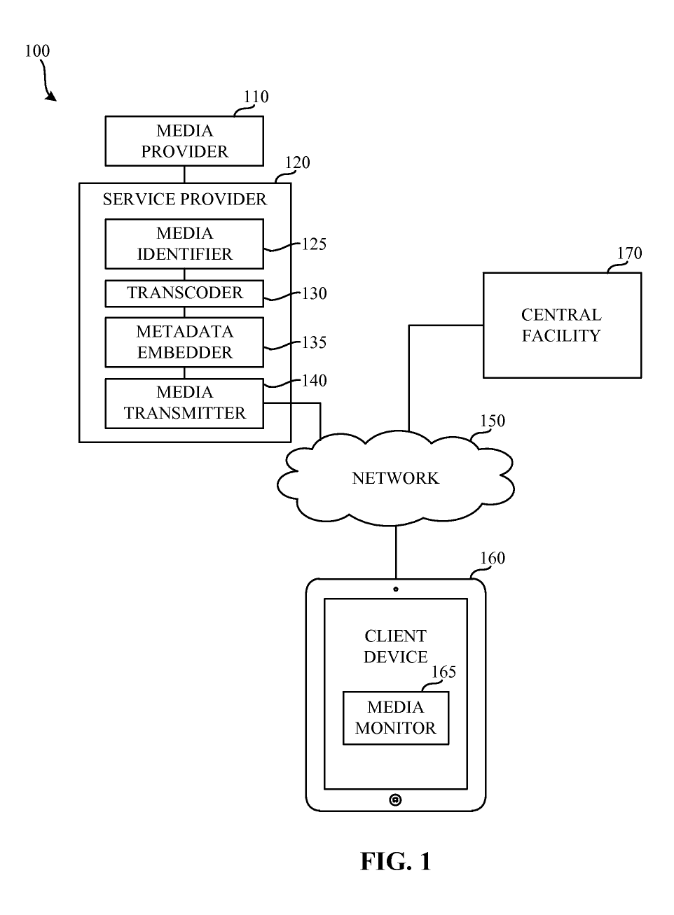

FIG. 1 is a block diagram of an example system 100 constructed in accordance with the teachings of this disclosure for measuring exposure to streaming media. The example system 100 of FIG. 1 monitors media provided by an example media provider 110 for presentation on an example client device 160 via an example network 150. The example of FIG. 1 includes an example service provider 120, an example media monitor 165, and an example central facility 170 of an audience measurement entity. While the illustrated example of FIG. 1 discloses an example implementation of the service provider 120, other example implementations of the service provider 120 may additionally or alternatively be used, such as the example implementations disclosed in co-pending U.S. patent application Ser. No. 13/341,646, which is hereby incorporated by reference herein in its entirety.

The media provider 110 of the illustrated example of FIG. 1 corresponds to any one or more media provider(s) capable of providing media for presentation at the client device 160. The media provided by the media provider(s) 110 can provide any type of media, such as audio, video, multimedia, etc. Additionally, the media can correspond to live (e.g., broadcast) media, streaming media, stored media, on-demand content, etc.

The service provider 120 of the illustrated example of FIG. 1 provides media services to the client device 160 via, for example, web pages including links (e.g., hyperlinks, embedded media, etc.) to media provided by the media provider 110. In the illustrated example, the service provider 120 modifies the media provided by the media provider 110 prior to transmitting the media to the client device 160. In the illustrated example, the service provider 120 includes an example media identifier 125, an example transcoder 130, an example metadata embedder 135, and an example media transmitter 140.

The media identifier 125 of the illustrated example of FIG. 1 is implemented by a logic circuit such as a processor executing instructions, but it could additionally or alternatively be implemented by an application specific integrated circuit(s) (ASIC(s)), programmable logic device(s) (PLD(s)) and/or field programmable logic device(s) (FPLD(s)), an analog circuit, and/or other circuitry. The media identifier 125 of FIG. 1 extracts metering data (e.g., signatures, watermarks, etc.) from the media obtained from the media provider 110. For example, the media identifier 125 can implement functionality provided by a software development kit (SDK) to extract one or more audio watermarks, one or more video (e.g., image) watermarks, etc., embedded in the audio and/or video of the media obtained from the media provider 110. (For example, the media may include pulse code modulation (PCM) audio data or other types of audio data, uncompressed video/image data, etc.)

The example media identifier 125 of FIG. 1 determines (e.g., derives, decodes, converts, etc.) the metering data (e.g., such as media identifying information, source identifying information, etc.) included in or identified by a watermark embedded in, associated with, and or transmitted with the media, and converts this metering data into a text and/or binary format for inclusion in an ID3 tag and/or other data type (e.g., text, binary, etc.) for insertion as metadata in a timed text track associated with the streaming media.

The example transcoder 130 of the illustrated example of FIG. 1 is implemented by a logic circuit such as a processor executing instructions, but could additionally or alternatively be implemented by an analog circuit, ASIC, DSP, FPGA, and/or other circuitry. In some examples, the transcoder 130 and the media identifier 125 are implemented by the same physical processor. In the illustrated example, the transcoder 130 employs any appropriate technique(s) to transcode and/or otherwise process the received media into a form suitable for streaming (e.g., a streaming format). For example, the transcoder 130 of the illustrated example transcodes the media in accordance with MPEG 4 audio/video compression for use via the HLS protocol.

The metadata embedder 135 of the illustrated example of FIG. 1 is implemented by a logic circuit such as a processor executing instructions, but could additionally and/or alternatively be implemented by an analog circuit, ASIC, DSP, FPGA, and/or other circuitry. In some examples, the transcoder 130, the media identifier 125, and the metadata embedder 135 are implemented by the same physical processor.

In the illustrated example, the metadata embedder 135 embeds the metadata determined by the media identifier 125 into a timed text track document. In the illustrated example, the timed text track is in a Web Video Text Track (WebVTT) format. However, any other past, present, and/or future format such as, for example, a Timed Text Markup Language (TTML) format may additionally or alternatively be used. In some examples, the metadata embedder 135 inserts ID3 tag metadata corresponding to the metering metadata into the timed text track document to identify particular events within the media such as, for example, when an advertisement is displayed via product placement, when a dedicated advertisement is displayed, when a particular event occurs within the media (e.g., when a contestant on a television game show answers a question, when a televised movie returns from an advertisement, etc.), etc. Additionally or alternatively, the metadata embedder 135 may embed the metadata into a separate metadata document, such as by encoding the metadata into an M3U8 or other data file that is to be associated with (e.g., included in, appended to, sent prior to, etc.) the media.

The media transmitter 140 of the illustrated example of FIG. 1 is implemented by a logic circuit such as a processor executing instructions, but could additionally or alternatively be implemented by an analog circuit, ASIC, DSP, FPGA, and/or other circuitry. In some examples, the transcoder 130, the media identifier 125, the metadata embedder 135, and the media transmitter 140 are implemented by the same physical processor.

The media transmitter 140 employs any appropriate technique(s) to select and/or stream the media to a requesting device, such as the client device 160. For example, the media transmitter 140 of the illustrated example selects media that has been identified by the media identifier 125, transcoded by the transcoder 130 and undergone metadata embedding by the metadata embedder 135. The media transmitter 140 then streams the media to the client device 160 via the network 150 using HLS or any other streaming protocol.

In some examples, the media identifier 125, the transcoder 130, and/or the metadata embedder 130 prepare media for streaming regardless of whether (e.g., prior to) a request is received from the client device 160. In such examples, the already-prepared media is stored in a data store of the service provider 120 (e.g., such as in a flash memory, magnetic media, optical media, etc.). In such examples, the media transmitter 140 prepares a transport stream for streaming the already-prepared media to the client device 160 when a request is received from the client device 160. In other examples, the media identifier 125, the transcoder 130, and/or the metadata embedder 130 prepare the media for streaming in response to a request received from the client device 160.

The network 150 of the illustrated example is the Internet. Additionally or alternatively, any other network(s) communicatively linking the service provider 120 and the client device such as, for example, a private network, a local area network (LAN), a virtual private network (VPN), etc. may be used. The network 150 may comprise any number of public and/or private networks using any type(s) of networking protocol(s).

The client device 160 of the illustrated example of FIG. 1 is a computing device that is capable of presenting streaming media provided by the media transmitter 140 via the network 150. The client device 160 may be, for example, a tablet, a desktop computer, a laptop computer, a mobile computing device, a television, a smart phone, a mobile phone, an Apple® iPad®, an Apple® iPhone®, an Apple® iPod®, an Android™ computing device, a Palm® webOS® computing device, etc. In the illustrated example, the client device 160 includes a media monitor 165. In the illustrated example, the media monitor 165 is implemented by a media player (e.g., a browser, a local application, etc.) that presents streaming media provided by the media transmitter 140. For example, the media monitor 165 may additionally or alternatively be implemented in Adobe® Flash® (e.g., provided in a SWF file), may be implemented in hypertext markup language (HTML) version 5 (HTML5), may be implemented in Google® Chromium®, may be implemented according to the Open Source Media Framework (OSMF), may be implemented according to a device or operating system provider's media player application programming interface (API), may be implemented on a device or operating system provider's media player framework (e.g., the Apple® iOS® MPMoviePlayer software), etc., or any combination thereof. In the illustrated example, the media monitor 165 reports metering data to the central facility 170. While a single client device 160 is illustrated, any number and/or type(s) of media presentation devices may be used.

The central facility 170 of the illustrated example is a facility of an audience measurement entity (e.g., the Nielsen Company (US) LLC) and includes an interface to receive reported metering information (e.g., metadata) from the media monitor 165 of the client device 160 via the network 150. In the illustrated example, the central facility 170 includes an HTTP interface to receive HTTP requests that include the metering information. The HTTP requests are sent with the metering information in their payload. The requests may not be intended to actually retrieve content, but are instead used as a vehicle to convey the metering information. The central facility 170 is provided with software (e.g., a daemon) to extract the metering information from the payload of the request(s). Additionally or alternatively, any other method(s) to transfer the metering information may be used such as, for example, an HTTP Secure protocol (HTTPS), a file transfer protocol (FTP), a secure file transfer protocol (SFTP), an HTTP and/or HTTPS GET request, an HTTP and/or HTTPS POST request, etc. In the illustrated example, the central facility 170 stores and analyzes the extracted metering information received from a plurality of different client devices. For example, the central facility 170 may sort and/or group metering information by media provider 110 (e.g., by grouping all metering data associated with a particular media provider 110). Any other processing of metering information may additionally or alternatively be performed. In some examples, the central facility 170 adds a timestamp to the metadata upon receipt. Timestamping (e.g., recording a time that an event occurred) enables accurate identification and/or correlation of media that was presented and/or the time that it was presented with the user(s) of the presentation device.

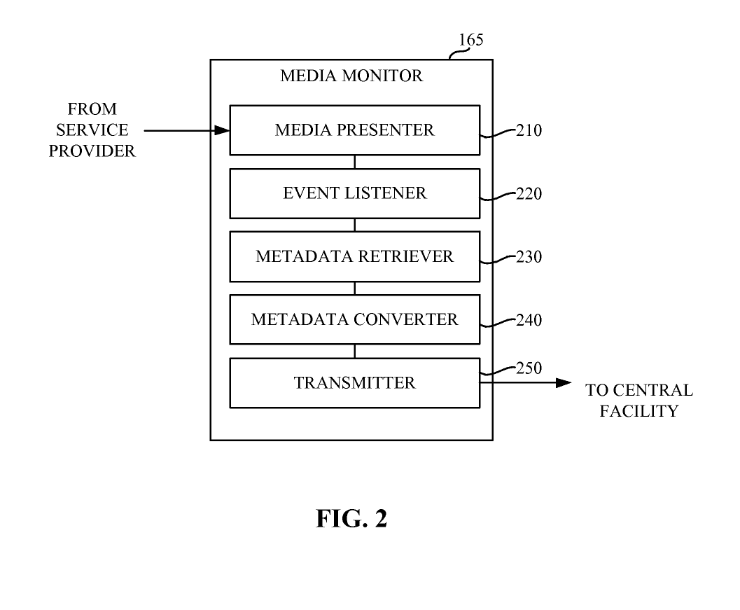

FIG. 2 is a block diagram of an example implementation of the media monitor 165 of FIG. 1. The media monitor 165 of the illustrated example of FIG. 2 includes an example media presenter 210, an example event listener 220, an example metadata retriever 230, an example metadata converter 240, and an example transmitter 250.

The example media presenter 210 of FIG. 2 is implemented by a processor executing instructions, but it could additionally or alternatively be implemented by an analog circuit, an ASIC, DSP, FPGA, and/or other circuitry. In the illustrated example, the media presenter 210 interacts with a QuickTime® application programming interface (API) to display media via the client device 160. While in the illustrated example, the QuickTime® API is used, any other media presenting framework may additionally or alternatively be employed. For example, the example media presenter 210 may interact with an Adobe® Flash® media presentation framework. In the illustrated example, the media presenter 210 reads a timed text track file. An example timed text track file is shown in FIG. 4. Upon certain timed events as defined in the timed text track, cued events are triggered by the media presenter 210. At a given time such as, for example, two seconds into the presentation of the media, a timed event may be triggered that in some examples, invokes the example event listener 220. In the illustrated example, the data contained in the timed text track is not displayed by the media presenter 210. However, in some examples, the data contained in the timed text track is displayed by the media presenter 210.

The example event listener 220 of the illustrated example of FIG. 2 is implemented by a logic circuit such as a processor executing instructions, but it could additionally or alternatively be implemented by an analog circuit, an ASIC, DSP, FPGA, and/or other circuitry. In some examples, the media presenter 210 and the event listener 220 are implemented by the same physical processor. In the illustrated example, the example event listener 220 interfaces with JavaScript functions to enable reception of and/or listening for an event notification. While JavaScript is used to listen for event notifications in the illustrated example, any other script, language, instruction set, and/or framework, such as, for example, ActiveX, Microsoft Silverlight, etc., may be used to listen for event notifications.

The metadata retriever 230 of the illustrated example of FIG. 2 is implemented by a logic circuit such as a processor executing instructions, but it could additionally or alternatively be implemented by an analog circuit, an ASIC, DSP, FPGA, and/or other circuitry. In some examples, the media presenter 210, the event listener 220, and the metadata retriever 230 are implemented by the same physical processor. In the illustrated example, the metadata retriever 230 retrieves metadata from the media presenter 210 upon detection of an event notification by the event listener 220. In the illustrated example, the metadata retriever 230 retrieves the metadata by inspecting a document object model (DOM) object associated with the timed text track of the media presenter 210 using JavaScript. The DOM object is a representation of the timed text track within the media presenter 210 that is created when the media presenter 210 reads the timed text track file. An example of such retrieval is shown in block 330 and/or 350 of FIG. 3. While JavaScript is used to retrieve the DOM object in the illustrated example, any other script, language, instruction set, and/or framework, such as, for example, ActiveX, Microsoft Silverlight, etc., may be used to retrieve the DOM object.

The example metadata converter 240 of FIG. 2 is implemented by a logic circuit such as a processor executing instructions, but it could additionally or alternatively be implemented by an analog circuit, an ASIC, DSP, FPGA, and/or other circuitry. In some examples, the media presenter 210, the event listener 220, the metadata retriever 230, and the metadata converter 240 are implemented by the same physical processor. In the illustrated example, the metadata converter 240 converts the metadata retrieved by the metadata retriever 230 into a converted metadata format for transmission to the central facility 170. For example, the metadata converter 240 may encrypt, decrypt, compress, modify, etc., the metadata and/or portions of the metadata to, for example, reduce the amount of data to be transmitted to the central facility 170. In the illustrated example, the metadata converter 240 adds a timestamp to the metadata prior to converting the metadata. Timestamping (e.g., recording a time that an event occurred) enables accurate identification and/or correlation of media that was presented and/or the time that it was presented with the user(s) of the presentation device.

The transmitter 250 of the illustrated example of FIG. 2 is implemented by a logic circuit such as a processor executing instructions, but it could additionally or alternatively be implemented by an analog circuit, an ASIC, DSP, FPGA, and/or other circuitry. In some examples, the media presenter 210, the event listener 220, the metadata retriever 230, the metadata converter 240, and the transmitter 250 are implemented by the same physical processor. In the illustrated example, the transmitter 250 transmits the converted metadata to the central facility 170 via, for example, the Internet. While the converted metadata is transmitted in substantially real-time in the illustrated example, in some examples, the converted metadata is stored, cached, and/or buffered before being transmitted to the central facility 170. Also, while the converted metadata is additionally or alternatively transmitted to the central facility 170 in the illustrated example, in some examples, the metadata is additionally or alternatively transmitted to a different destination such as, for example, a display of the media monitor 165 and/or the client device 160. Additionally or alternatively, the transmitter 250 may transmit an identifier of the media monitor 165 and/or the client device 160 to enable the central facility 170 to correlate the metadata with a panelist, a group of panelists, demographic(s), etc. In the illustrated example, the central facility 170 is associated with an audience measurement company and is not involved with the delivery of media to the client device. In some examples, the central facility 170 applies a timestamp upon receipt of the converted metadata.

FIG. 3 illustrates example Hypertext Markup Language (HTML) instructions 300 representing a web page that may be executed by the example media monitor 165 of FIG. 2 when included in the client device 160 of FIG. 1. In the illustrated example, an example video tag 310 implements the example media presenter 210 of FIG. 2. In the illustrated example, the media presenter 210 is implemented with a media source having a universal resource indicator (URI), a frame having a given height and width, and an identifier. In the illustrated example, the example video tag 310 includes a text track instruction 315 indicating a timed text track file associated with the video of the example video tag 310. The text track instruction 315 of the illustrated example indicates that the source of the associated text track is “track_file.vtt.” However, any other file may additionally or alternatively be used. In the illustrated example, one text track instruction 315 is included. However, in some examples, additional and/or alternative text track instructions are included. For example, additional or alternative text tracks may include closed captions, different versions of metadata (e.g., metadata presented in a different format, metadata presented in a different language, metadata customized for a particular service provider, etc.), etc.

An example “addeventlistener” function 320 included in the example HTML code 300 of FIG. 3 implements the event listener 220 of FIG. 2. In the illustrated example, the event listener 220 is loaded by specifying the intended HTML element (e.g., the element identified as having an id of ‘track’), specifying an event type (e.g., “cuechange”, etc.), and specifying that the function “TrackChangeFunction” should be executed when the event is detected. In the illustrated example, the event type that is detected is “cuechange”, which is an event that is triggered by the media presenter 210. However, any other type of event may additionally or alternatively used, such as, for example, an event type associated with a different media presenter, an event type associated with a different trigger of the media presenter 210, an event type associated with a different program than QuickTime® (“QT”), etc.

An example instruction group function 330 included in the example HTML code 300 of FIG. 3 retrieves metadata associated with the HTML object that triggered the “TrackChangeFunction( )”. In the illustrated example, when the video tag 310 is played by the media presenter 210, events will be triggered according to the events defined in the timed text track file identified by the text track instruction 315. In the illustrated example, the metadata is retrieved from the “track” object as indicated in the getElementById function of instruction 320. In the illustrated example, the retrieved metadata is stored (e.g., cached, buffered, etc.) in a local variable “myCues”.

In the illustrated example, the retrieved metadata is in an ID3 format. However, in some examples the retrieved metadata may be in another past, present, and/or future format such as, for example, JavaScript Object Notation (JSON). In some examples, the metadata is stored as a hash value. In some examples, the HTML code 300 of FIG. 3 further includes function(s) to convert the metadata stored in a first format into a second format.

In the illustrated example, block 350 of the example HTML code 300 of FIG. 3 transmits the converted metadata to a text area 351 (defined in the illustrated example as “display”). In some examples, block 350 is modified to additionally or alternatively transmit the converted metadata to the central facility 170. In some examples, the metadata is transmitted in the ID3 format (block 350). In some examples, block 350 transmits other information such as, for example, user identifying information, client information, timestamps, identifiers, etc., in addition or as an alternative to the metadata.

FIG. 4 illustrates example timed text track code 400 representing an example timed text track that may be used by the example media monitor of FIG. 2. In the illustrated example, the timed text code 400 is in a WebVTT format, as indicated by a format identifier 415. However, the timed text code 400 may be in any other past, present, and/or future format such as, for example, a Timed Text Markup Language (TTML) format, etc. The timed text code 400 of FIG. 4 includes a first timed event 410. The first timed event 410 includes a start time 411 and an end time 412. The first timed event 410 includes metadata 420 formatted in an ID3 format. In particular, the metadata 420 includes a contentid section that includes identifying information 425. In the illustrated example, the identifying information 425 identifies the media being presented via the associated media stream.

FIG. 4 illustrates a progression through time of the associated media. For example, FIG. 4 shows time A 450, time B 460, time C 470, and time D 480. In the illustrated example, during a first time period after the time A 450 and before the time B 460, a first segment of a television show is presented. During a second time period after the time B 460 and before the time C 470, an advertisement is presented. During a third time period after the time C 470 and before the time D 480, a second segment of the television show is presented.

The timed text track code 400 describes cue change events that are to be triggered in association with the presentation of the media. In the illustrated example, the first time segment is identified by the first timed event 410. The identifying information 425 of the metadata 420 of the first timed event 410 identifies the first segment of the television show. In the illustrated example, the first timed event 410 is triggered after one second of media has been presented. The first timed event 410 is triggered after one second of media has been presented because, in some examples the event listener function 320 may not have loaded within the first second of media playback. In some examples, alternative start times are used such as, for example, zero seconds (e.g., no delay), five seconds, ten seconds, one minute, etc.

In the illustrated example, the second time period is identified by a second timed event 440. The second timed event 440 begins one second after the completion of the first time segment. However, any other time delay may additionally or alternatively be used. The second timed event 440 includes metadata identifying the advertisement displayed during the second time segment.

In the illustrated example, the third time period is identified by a third timed event 445. The third timed event 445 begins one second after the completion of the second timed event 440. However, any other time delay may additionally or alternatively be used. The third timed event 445 includes metadata identifying the second segment of the television show. In the illustrated example, the metadata identifying the second segment of the television show is different from the metadata identifying the first segment of the television show. However, in some examples, the metadata identifying the second segment of the television show is the same as the metadata identifying the first segment of the television show.

In the illustrated example, a cue change event is triggered at the start of each of the timed events (e.g., the first timed event 410, the second timed event 440, the third timed event 445, etc.). Thus, the timed events 410, 440, 445 occur when the media is within a different time segment defined by the timed text track than was previously presented (including the start of media presentation). In the illustrated example, the timed text track time segments and corresponding timed events are divided into segments corresponding to the media presented (e.g., the first timed event is associated with the first segment of the television show, the second timed event 440 is associated with the advertisement, etc.).

In some examples, the timed text track events are divided into fixed length segments (e.g., five seconds, ten seconds, one minute, etc.) and are associated with the media presented within the respective fixed length segments. Segmenting the timed text track into segments facilitates accurate collection of media monitoring data, as more data points representing various times within the media presentation are collected. When used with timestamps, using small segments (e.g., thirty seconds, one minute, etc.) facilitates detection of other media interaction events such as, for example, skip, stop, pause, play, events because expected time durations between timed text track cue changes can be compared to actual time durations between timed text track cue changes. In some examples, the timed text track is not divided into separate segments and includes a single segment spanning the entire presentation of the media.

While example manners of implementing the service provider 120 of FIG. 1 and/or the example media monitor 165 of FIGS. 1 and/or 2 have been illustrated in FIGS. 1 and/or 2, one or more of the elements, processes and/or devices illustrated in FIGS. 1 and/or 2 may be combined, divided, re-arranged, omitted, eliminated and/or implemented in any other way. Further, the example media identifier 125, the example transcoder 130, the example metadata embedder 135, the example media transmitter 140, and/or, more generally, the example service provider 120 of FIG. 1, and/or the example media presenter 210, the example event listener 220, the example metadata retriever 230, the example metadata converter 240, the example transmitter 250, and/or, more generally, the example media monitor 165 of FIGS. 1 and/or 2 may be implemented by hardware, software, firmware and/or any combination of hardware, software and/or firmware. Thus, for example, any of the example media identifier 125, the example transcoder 130, the example metadata embedder 135, the example media transmitter 140, and/or, more generally, the example service provider 120 of FIG. 1, and/or the example media presenter 210, the example event listener 220, the example metadata retriever 230, the example metadata converter 240, the example transmitter 250, and/or, more generally, the example media monitor 165 of FIGS. 1 and/or 2 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example media identifier 125, the example transcoder 130, the example metadata embedder 135, the example media transmitter 140, the example media presenter 210, the example event listener 220, the example metadata retriever 230, the example metadata converter 240, and/or the example transmitter 250 are hereby expressly defined to include a tangible computer readable medium such as a memory, DVD, CD, Blu-ray, etc. storing the software and/or firmware. Further still, the example media identifier 125, the example transcoder 130, the example metadata embedder 135, the example media transmitter 140, and/or, more generally, the example service provider 120 of FIG. 1, and/or the example media presenter 210, the example event listener 220, the example metadata retriever 230, the example metadata converter 240, the example transmitter 250, and/or, more generally, the example media monitor 165 of FIGS. 1 and/or 2 may include one or more elements, processes and/or devices in addition to, or instead of, those illustrated in FIGS. 1 and/or 2, and/or may include more than one of any or all of the illustrated elements, processes and devices.

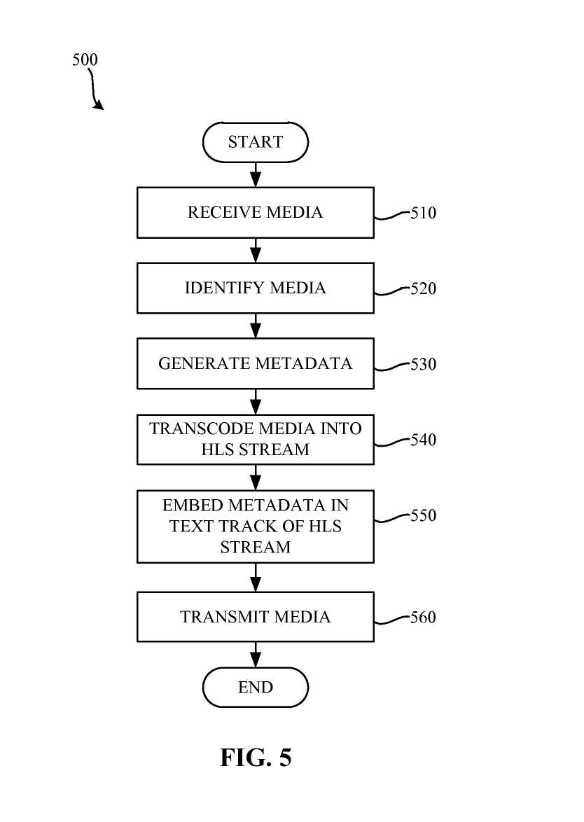

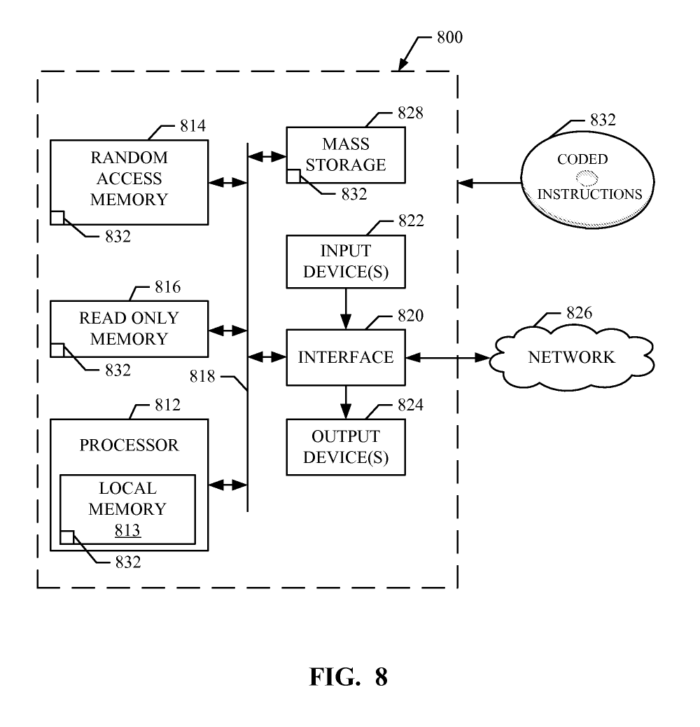

Flowcharts representative of example machine-readable instructions for implementing the service provider 120 of FIG. 1 and/or the media monitor 165 of FIGS. 1 and/or 2 are shown in FIGS. 5 and/or 6. In these examples, the machine-readable instructions comprise a program for execution by a logic circuit such as the processor 812 shown in the example processor platform 800 discussed below in connection with FIG. 8. The program(s) may be embodied in software stored on a tangible computer-readable medium such as a computer readable storage medium (e.g., a CD-ROM, a floppy disk, a hard drive, a digital versatile disk (DVD), a Blu-ray disk, or a memory associated with the processor 812), but the entire program and/or parts thereof could alternatively be executed by a device other than the processor 812 and/or embodied in firmware or dedicated hardware. Further, although the example program is described with reference to the flowcharts illustrated in FIGS. 5 and/or 6, many other methods of implementing the example the example service provider 120 of FIG. 1 and/or the example media monitor 165 of FIGS. 1 and/or 2 may alternatively be used. For example, the order of execution of the blocks may be changed, and/or some of the blocks described may be changed, eliminated, or combined.

As mentioned above, the example processes of FIGS. 5 and/or 6 may be implemented using coded instructions (e.g., computer-readable instructions) stored on a tangible computer-readable medium such as a computer readable storage medium (e.g., a hard disk drive, a flash memory, a read-only memory (ROM), a compact disk (CD), a digital versatile disk (DVD), a cache, a random-access memory (RAM)) and/or any other storage media in which information is stored for any duration (e.g., for extended time periods, permanently, brief instances, for temporarily buffering, and/or for caching of the information). As used herein, the term tangible computer-readable medium is expressly defined to include any type of computer-readable storage medium and to exclude propagating signals. Additionally or alternatively, the example processes of FIGS. 5 and/or 6 may be implemented using coded instructions (e.g., computer-readable instructions) stored on a non-transitory computer-readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer-readable medium is expressly defined to include any type of computer-readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 5 is a flowchart representative of example machine-readable instructions 500 which may be executed to implement the example service provider 120 of FIG. 1. Execution of the example machine-readable instructions 500 of FIG. 5 begins with the media identifier 125 of the service provider 120 receiving the media from the media provider 110 (block 510). In the illustrated example, the media is received as it is broadcast (e.g., live). However, in some examples, the media is stored and/or cached by the media identifier 125.

The media identifier 125 of the illustrated example then identifies the media (block 520). The media identifier 125 identifies the media by extracting metering data (e.g., signatures, watermarks, codes, etc.) from the media. Based on the extracted metering data, the media identifier 125 generates metadata (block 530). In the illustrated example, the metadata is generated in an ID3 format. However, any other metadata format may additionally or alternatively be used. Further, in the illustrated example, the metadata is generated based on the extracted metering data. However, in some examples, the metadata may be generated by querying an external source using some or all of the extracted metering data.

The media is then transcoded by the transcoder 130 of the service provider 120 (block 540). In the illustrated example, the media is transcoded into an MPEG2 transport stream that may be transmitted via HTTP live streaming (HLS). In particular, the metadata embedder 135 of the service provider 120 embeds the metadata into a timed text track associated with the HLS stream (block 550). In the illustrated example, the metadata is embedded in a timed text track document that is external to the HLS stream. However, in some examples, the metadata is embedded into the media itself as, for example, closed captioning data. For example, the timed text track information may be encoded in an MPEG2 transport stream as closed captioning data that may trigger timed events in a similar manner to an external timed text track. In the illustrated example, the metadata embedded into the timed text track identifies different media being presented at different times.

The media is then transmitted by the media transmitter 140 of the service provider 120 (block 560). In the illustrated example, the media is transmitted using HTTP live streaming (HLS). However, any other format and/or protocol for transmitting (e.g., broadcasting, unicasting, multicasting, etc.) media may additionally or alternatively be used.

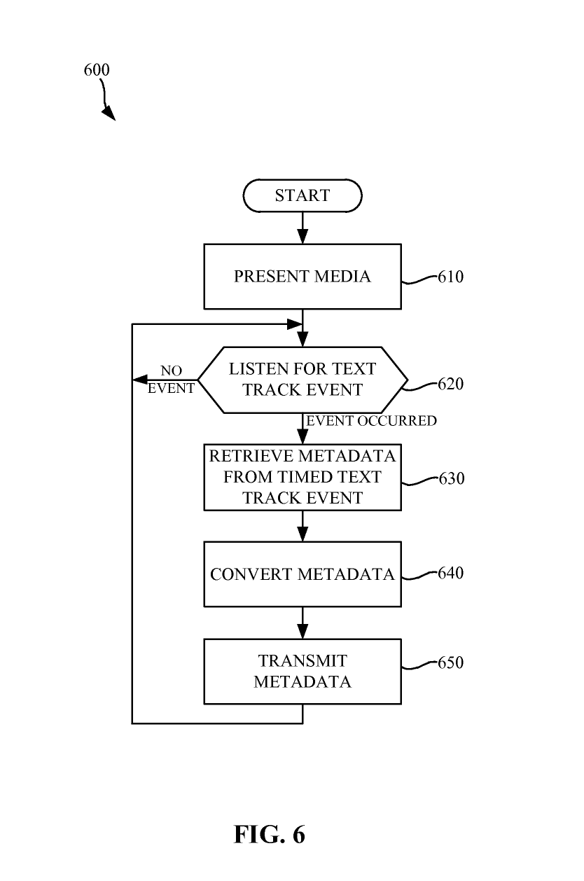

FIG. 6 is a flowchart representative of example machine-readable instructions 600 which may be executed to implement the example media monitor 165 of FIGS. 1 and/or 2. Execution of the example machine-readable instructions 600 of FIG. 6 begins with the media monitor 165 being loaded by the client device 160. The media presenter 210 of the media monitor 165 then begins presenting media (block 610) by, for example, loading a display object for presentation via the client device 160. In the illustrated example, the display object is a QuickTime® object. However, any other type of display object may additionally or alternatively be used. When presenting the media, the media presenter 210 retrieves the timed text track file identified in association with the media (e.g., associated with the display object).

The event listener 220 of the media monitor 165 begins listening for an event (block 620). In the illustrated example, the event listener 220 listens for a JavaScript event triggered by the media presenter 210. In the illustrated example, the JavaScript event is a timed text track cue change event. However, in some examples, the event listener 220 listens for any other event(s) such as, for example, a media change event, a user interaction event (e.g., when a user clicks on an object), a display event (e.g., a page load), etc. If the event listener 220 does not detect an event, the event listener 220 continues to listen for the event until the media monitor 165 is closed. Unlike subtitling and/or advertisement display systems, the media monitor 165 of the illustrated example does not display information upon detection of the timed text track cue change event. For example, a subtitling and/or advertisement system may display subtitles and/or advertisements to a user during the media presentation based on timed text track cue change events and/or based on whether subtitles and/or advertisements are enabled within the media monitor 165. In contrast, data associated with the timed text track cue change event is not displayed to the user, regardless of whether subtitles and/or advertisements are enabled within the media monitor 165.

If the event listener 220 detects an event, the metadata retriever 230 of the media monitor 165 retrieves the metadata (block 630) from a DOM object representing the timed text track. In particular, in the illustrated example, the event listener 220 passes an event object to the metadata retriever 230. The metadata retriever 230 inspects the event object to retrieve the metadata. However, in some examples, the event listener 220 passes an identifier of an object (e.g., the media presenter 210 display object), which indicates the object from which the metadata retriever 230 is to retrieve metadata. In the illustrated example, the metadata is formatted as an ID3 tag. However, any other format of metadata may additionally or alternatively be used.

The metadata converter 240 of the media monitor 165 then converts the metadata (block 640) into a format for use by the transmitter 250 of the media monitor 165. In the illustrated example, the metadata is converted from a binary data format into a text format. In some examples, the metadata is parsed to identify portions (e.g., fields, sections, etc.) of interest of the metadata (e.g., a genre, an artist, a song title, an album name, a transmitting station/server site, etc.). In some examples, the metadata converter 240 embeds an identifier of the presentation device and/or an identifier of a user of the presentation device in the metadata. Including the identifier(s) of the presentation device and/or the user of the presentation device enables the central facility 170 to correlate the media that was presented with the presentation device and/or the user(s) of the presentation device. In the illustrated example, the metadata converter 240 adds a timestamp to the metadata prior to transmitting the metadata to the central facility 170. Timestamping (e.g., recording a time that an event occurred) enables accurate identification and/or correlation of media that was presented and/or the time that it was presented with the user(s) of the presentation device.

In some examples, the metadata may not undergo conversion before transmission by the transmitter (e.g., the metadata may be sent in the format in which it is retrieved by the metadata retriever 230). In such examples, the central facility 170 converts the metadata into a format for use by the central facility 170 by, for example, converting the metadata to a different format, parsing the metadata to identify portions of interest of the metadata, etc. Conversion of the metadata by the central facility 170 facilitates correlation of the media that was presented with an identifier identifying to whom the media was presented. In some examples, the central facility 170 timestamps the metadata upon receipt. Timestamping the metadata enables accurate identification and/or correlation of media that was presented and/or the time that it was presented with the user(s) of the presentation device.

The transmitter 250 then transmits the metadata to the central facility 170 (block 650). In the illustrated example, the metadata is transmitted using an HTTP Post request. However, any other method of transmitting data and/or metadata may additionally or alternatively be used. For example, a file transfer protocol (FTP), an HTTP Get request, Asynchronous JavaScript and extensible markup language (XML) (AJAX), etc., may be used to transmit the metadata. In some examples, the metadata is not transmitted to the central facility 170. For example, the metadata may be transmitted to a display object of the client device 160 for display to a user. In the illustrated example, the metadata is transmitted in real-time (e.g., streamed) to the central facility 170. However, in some examples, the metadata may be stored (e.g., cached, buffered, etc.) for a period of time before being transmitted to the central facility 170.

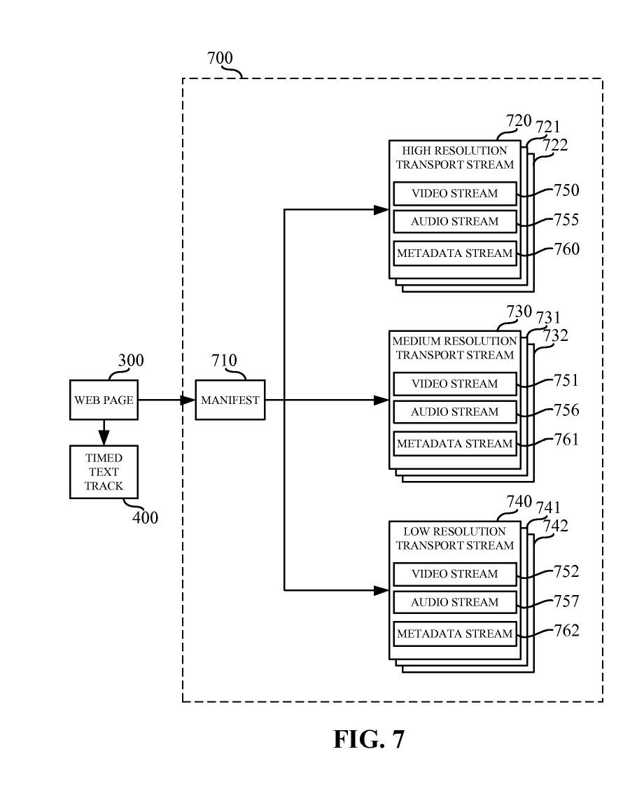

FIG. 7 is a block diagram of an example implementation of an example HLS stream 700 that may be displayed by the example media monitor of FIG. 2. In the illustrated example of FIG. 7, the HLS stream 700 includes a manifest 710 and three transport streams. However, any other number and/or type of transport streams may additionally or alternatively be used. In the illustrated example, the example HTML instructions 300 of FIG. 3 include an instruction to load the manifest 710. In the illustrated example, the example HTML instructions 300 of FIG. 3 include an instruction to load the timed text track 400 of FIG. 4. In the illustrated example, the manifest 710 is an .m3u8 file that describes the available transport streams to the client device. However, any other past, present, and/or future file format may additionally or alternatively be used. In some examples, the manifest 710 may be omitted and the media monitor 165 may directly access a transport stream. In the illustrated example, the client device retrieves the manifest 710 in response to an instruction to display an HLS element (e.g., a video element). For example, block 310 of FIG. 3 includes an instruction that the client device should present the HLS element identified by the manifest 710 stored at “movie.mp4”.

HLS is an adaptive format, in that, although multiple devices retrieve the same manifest 710, different transport streams may be displayed depending on one or more factors. For example, devices having different bandwidth availabilities (e.g., a high speed Internet connection, a low speed Internet connection, etc.) and/or different display abilities (e.g., a small size screen such as a cellular phone, a medium size screen such as a tablet and/or a laptop computer, a large size screen such as a television, etc.) select an appropriate transport stream for their display and/or bandwidth abilities. In some examples, a cellular phone having a small screen and limited bandwidth uses a low resolution transport stream. Alternatively, in some examples, a television having a large screen and a high speed Internet connection uses a high resolution transport stream. As the abilities of the device change (e.g., the device moves from a high speed Internet connection to a low speed Internet connection) the device may switch to a different transport stream.

In the illustrated example of FIG. 7, a high resolution transport stream 720, a medium resolution transport stream 730, and a low resolution transport stream 740 are shown. In the illustrated example, each transport stream 720, 730, and/or 740 represents a portion of the associated media (e.g., five seconds, ten seconds, thirty seconds, one minute, etc.). Accordingly, the high resolution transport stream 720 corresponds to a first portion of the media, a second high resolution transport stream 721 corresponds to a second portion of the media, a third high resolution transport stream 722 corresponds to a third portion of the media. Likewise, the medium resolution transport stream 730 corresponds to the first portion of the media, a second medium resolution transport stream 731 corresponds to the second portion of the media, and a third medium resolution transport stream 732 corresponds to the third portion of the media. In addition, the low resolution transport stream 740 corresponds to the first portion of the media, a second low resolution transport stream 741 corresponds to the second portion of the media, and a third low resolution transport stream 742 corresponds to the third portion of the media. Although three transport streams are shown in the illustrated example of FIG. 7 for each resolution, any number of transport streams representing any number of corresponding portions of the media may additionally or alternatively be used.

In the illustrated example, each transport stream 720, 721, 722, 730, 731, 732, 740, 741, and/or 742 includes a video stream 750, 751, 752, an audio stream 755, 756, 752, and a metadata stream 760, 761, 762. The video stream 750, 751, and/or 752 includes video associated with the media at different resolutions according to the resolution of the transport stream with which the video stream is associated. The audio stream 755, 756, and/or 757 includes audio associated with the media. The metadata stream 760, 761, and/or 762 includes metadata such as, for example, timed text track data, a link to the timed text track data, closed captioning data, and/or an ID3 tag associated with the media. In some examples, the metadata stream 760, 761, and/or 762 is not included as the information used to measure exposure to streaming media may already be transmitted to the media monitor 165 as the timed text track 400. In some examples, the metadata stream 760, 761, and/or 762 includes information that is not contained in the timed text track 400 (e.g., closed captioning information, etc.)

FIG. 8 is a block diagram of an example processor platform 800 capable of executing the example machine-readable instructions of FIGS. 5 and/or 6 to implement the example service provider 120 of FIG. 1 and/or the example media monitor 165 of FIGS. 1 and/or 2. The example processor platform 800 can be, for example, a server, a personal computer, a mobile phone (e.g., a cell phone), a tablet, a personal digital assistant (PDA), an Internet appliance, a DVD player, a CD player, a digital video recorder, a Blu-ray player, a gaming console, a personal video recorder, a set top box, or any other type of computing device.

The system 800 of the instant example includes a processor 812. For example, the processor 812 can be implemented by one or more microprocessors or controllers from any desired family or manufacturer.

The processor 812 includes a local memory 813 (e.g., a cache) and is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The computer 800 also includes an interface circuit 820. The interface circuit 820 may be implemented by any type of interface standard, such as an Ethernet interface, a universal serial bus (USB), and/or a PCI express interface.

One or more input devices 822 are connected to the interface circuit 820. The input device(s) 822 permit a user to enter data and commands into the processor 812. The input device(s) can be implemented by, for example, a keyboard, a mouse, a touchscreen, a track-pad, a trackball, isopoint and/or a voice recognition system.

One or more output devices 824 are also connected to the interface circuit 820. The output devices 824 can be implemented, for example, by display devices (e.g., a liquid crystal display, a cathode ray tube display (CRT), a printer and/or speakers). The interface circuit 820, thus, typically includes a graphics driver card.

The interface circuit 820 also includes a communication device (e.g., the media transmitter 140, the transmitter 250) such as a modem or network interface card to facilitate exchange of data with external computers via a network 826 (e.g., an Ethernet connection, a digital subscriber line (DSL), a telephone line, coaxial cable, a cellular telephone system, etc.).

The computer 800 also includes one or more mass storage devices 828 for storing software and data. Examples of such mass storage devices 828 include floppy disk drives, hard drive disks, compact disk drives, and digital versatile disk (DVD) drives.

The coded instructions 832 of FIGS. 5 and/or 6 may be stored in the mass storage device 828, in the volatile memory 814, in the non-volatile memory 816, in the local memory 813, and/or on a removable storage medium such as a CD or DVD.

Although certain example methods, apparatus, and articles of manufacture have been described herein, the scope of coverage of this patent is not limited thereto. On the contrary, this patent covers all methods, apparatus, and articles of manufacture fairly falling within the scope of the claims of this patent.

1. A method of measuring exposure to streaming media, the method comprising:
extracting metering data from media obtained from a media provider;
generating metadata identifying the media based on the extracted metering data;
transcoding the media into a transport stream, the transport stream having a streaming format; and
embedding the metadata in a timed text track accompanying the transport stream.

2. The method as described in claim 1, further comprising transmitting the transport stream and the timed text track to a requesting device.

3. The method as described in claim 2, wherein the media is obtained from the media provider in response to a request from the requesting device.

4. The method as described in claim 1, wherein the media obtained from the media provider is live media.

5. The method as described in claim 1, wherein the media obtained from the media provider is stored media.

6. The method as described in claim 1, wherein the streaming format is a HyperText Transfer Protocol (HTTP) Live Streaming (HLS) format.

7. The method as described in claim 1, wherein the metering data comprises data encoded in a watermark transmitted with the media.

8. The method as described in claim 7, wherein the watermark is an audio watermark.

9. The method as described in claim 7, wherein the watermark is a video watermark.

10. The method as described in claim 1, wherein the metadata is formatted as an ID3 tag.

11. An apparatus to measure exposure to streaming media, the apparatus comprising:
a media identifier to generate metadata identifying media based on metering data extracted from the media;
a transcoder to transcode the media into a transport stream; and
a metadata embedder to embed the metadata in a timed text track associated with the transport stream.

12. The apparatus as described in claim 11, further comprising a media transmitter to transmit the transport stream and the timed text track.

13. The apparatus as described in claim 11, wherein the transport stream is formatted in a streaming format.

14. The apparatus as described in claim 13, wherein the streaming format is a HyperText Transfer Protocol (HTTP) Live Streaming (HLS) format.

15. The apparatus as described in claim 11, wherein the metadata is formatted as an ID3 tag.

16. A machine-readable storage medium comprising instructions which, when executed, cause a machine to at least:
extract metering data from media obtained from a media provider;
generate metadata identifying the media based on the extracted metering data;
transcode the media into a transport stream, the transport stream having a streaming format; and
embed the metadata in a timed text track accompanying the transport stream.

17. The machine-readable medium as described in claim 16, further comprising instructions which, when executed, cause the machine to transmit the transport stream and the timed text track to a requesting device.

18. The machine-readable medium as described in claim 17, wherein the media is obtained from the media provider in response to a request from the requesting device.

19. The machine-readable medium as described in claim 16, wherein the media obtained from the media provider is live media.

20. The machine-readable medium as described in claim 16, wherein the media obtained from the media provider is stored media.

21. The machine-readable medium as described in claim 16, wherein the streaming format is a HyperText Transfer Protocol (HTTP) Live Streaming (HLS) format.

22. The machine-readable medium as described in claim 16, wherein the metering data comprises data encoded in a watermark transmitted with the media.

23. The machine-readable medium as described in claim 22, wherein the watermark is an audio watermark.

24. The machine-readable medium as described in claim 22, wherein the watermark is a video watermark.

25. The machine-readable medium as described in claim 16, wherein the metadata is formatted as an ID3 tag.

26-40. (canceled)
